(19) United States
(12) Patent Application Publication
(10) Pub. No.: US 2015/0240906 A1
(43) Pub. Date: Aug. 27, 2015

(54) SHOCK ABSORBER

(71) Applicant: Aopen Inc., New Taipei City (TW)

(72) Inventor: Jo-Chiao WANG, New Taipei City (TW)

(21) Appl. No.: 14/323,879

(22) Filed: Jul. 3, 2014

(30) Foreign Application Priority Data
Feb. 27, 2014 (TW) 103203480

(51) Int. Cl. F16F 15/08; F16M 13/02

(52) U.S. Cl. CPC F16F 15/08; F16M 13/02

(57) ABSTRACT

A shock absorber includes assembling element, absorbing element and locking element. The assembling element includes assembling plate and buffer plate. The assembling plate is connected to the buffer plate. The buffer plate has assembling hole. The absorbing element has absorbing body and convex part. The absorbing body has opening hole. The absorbing body is detachably installed on the assembling hole, and the convex part is located on the absorbing element. The locking element has head part, protruding part and threaded part. The head part has limit surface. The protruding part protrudes from the head part and has limit surface. The threaded part protrudes from limit surface. The locking element passes through the first opening hole. The threaded part is used to fix a load to make the limit surface being abutted on the load, which makes the absorbing elements being elastically clamped between the limit surface and the load.

### CROSS-REFERENCE TO RELATED APPLICATIONS

This non-provisional application claims priority under 35 U.S.C. §119(a) on Patent Application No(s). 103203480 filed in Taiwan, R.O.C. on 2014 Feb. 27, the entire contents of which are hereby incorporated by reference.

### BACKGROUND

1. Technical Field

The disclosure relates to a shock absorber, more particularly to a shock absorber for an electronic device.

2. Related Art

With the advance of technology, computers are getting more and more powerful and are more important than ever before. A current computer system mainly includes a case, a main board, a disk, and a power supply. Among these computer components, the disk is likely to be disturbed by the vibration because the disk uses the heads to read and write the data in the storage area. The heads may collide with the storage area if being influenced by the vibration. Therefore, the disk may be damaged or the transmission efficiency of the disk may be affected negatively. Generally speaking, the manufacturers dispose a shock absorber surrounding the disk to prevent the disk from vibration.

Most of the shock absorbers use an elastic washer because of cost considerations. The washer is sandwiched between the disk and the case to dissipate the vibrating wave. However, the shock absorber using the washer is not able to pass industry computer vibration tests because the specifications now are more stringent. Therefore, it is important to provide a better shock absorber to pass the industry computer vibration tests.

### SUMMARY

The disclosure provides a shock absorber comprising an assembling element, a plurality of first absorbing elements and a plurality of first locking elements. The assembling element includes two assembling plates and a buffer plate which is curved. The two assembling plates are respectively connected to opposite two sides of the buffer plate, and the buffer plate has a plurality of first assembling holes. The first absorbing elements have a first absorbing body and a plurality of first convex parts respectively. Each of the first absorbing bodies has a first opening hole. The first absorbing bodies are detachably installed on the first assembling holes, and the first convex parts are located on one side of the first absorbing element. The first locking elements have a head part, a protruding part and a threaded part respectively. The head part has a first limit surface. The protruding part protrudes from the head part and has a second limit surface. The threaded part protrudes from the second limit surface. Vertical distance between the first limit surface and the second limit surface is less than thickness of the first absorbing element. The first locking elements pass through the first opening holes respectively. The first limit surfaces of the first locking elements are abutted on the first convex parts of the first absorbing bodies respectively. The threaded parts of the first locking elements are configured to fix a load to make the second limit surfaces being abutted on the load surface, which makes the first absorbing elements being elastically clamped between the first limit surfaces and the load surface.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1A is a perspective view of a shock absorber, a case and a load according to a first embodiment;

FIG. 1B is a top view of FIG. 1A;

FIG. 2A is an exploded view of an assembling element and the case in FIG. 1A;

FIG. 2B is an exploded view of the assembling element and the load in FIG. 2A;

FIG. 3 is a cross-sectional view of the assembling element in FIG. 1A;

FIG. 4 is a top view of the assembling element in FIG. 2B;

FIG. 5 is an exploded view of a first absorbing element and a first locking element in FIG. 2B;

FIG. 6 is an exploded view of a second absorbing element and a second locking element in FIG. 2A; and

FIG. 7 to FIG. 11 are assembling drawings of the shock absorber, the case, and the load in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

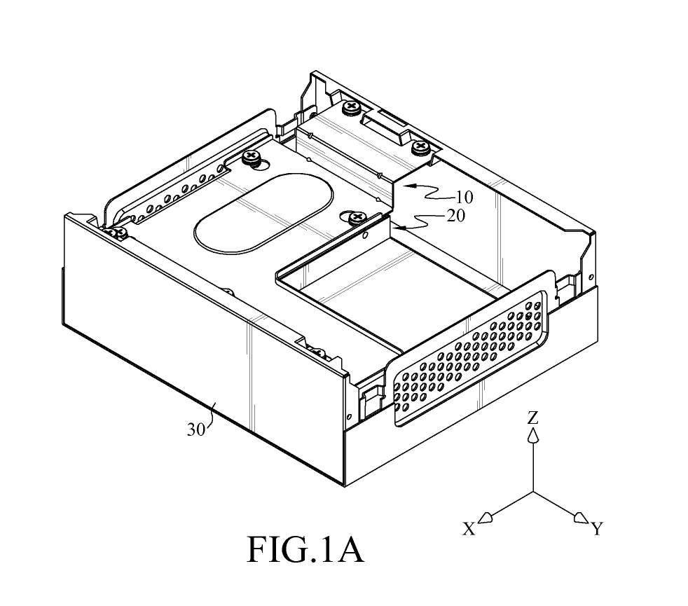

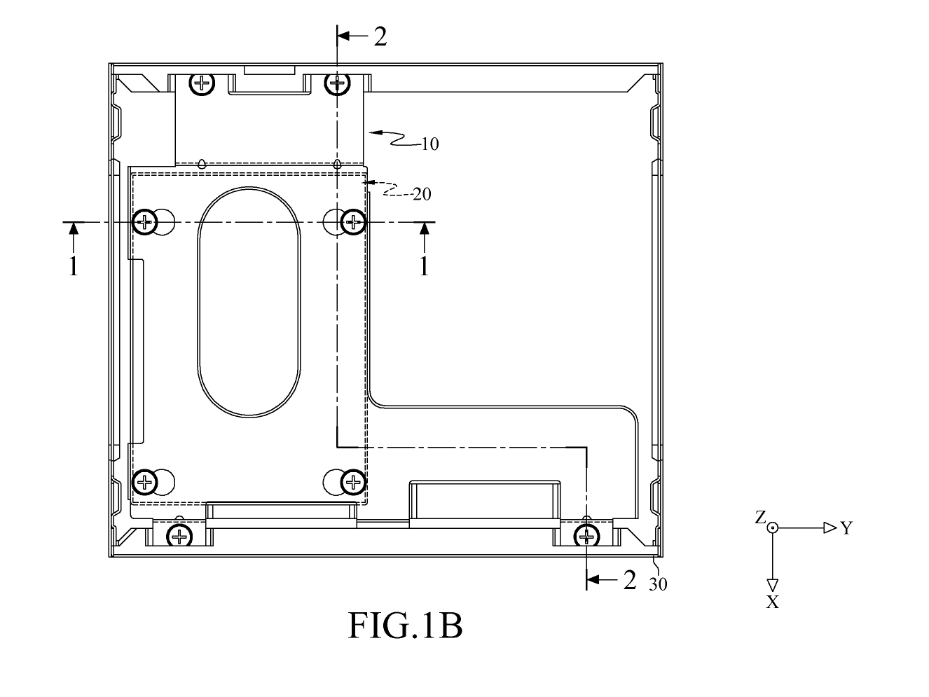

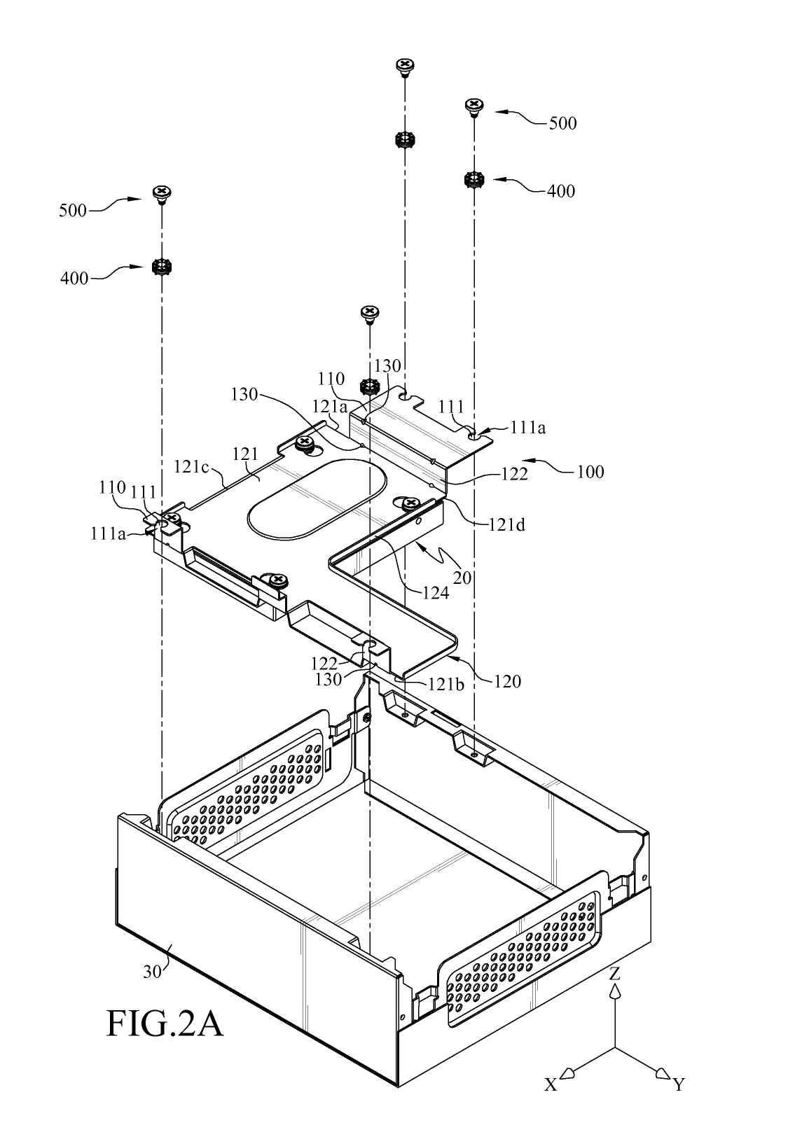

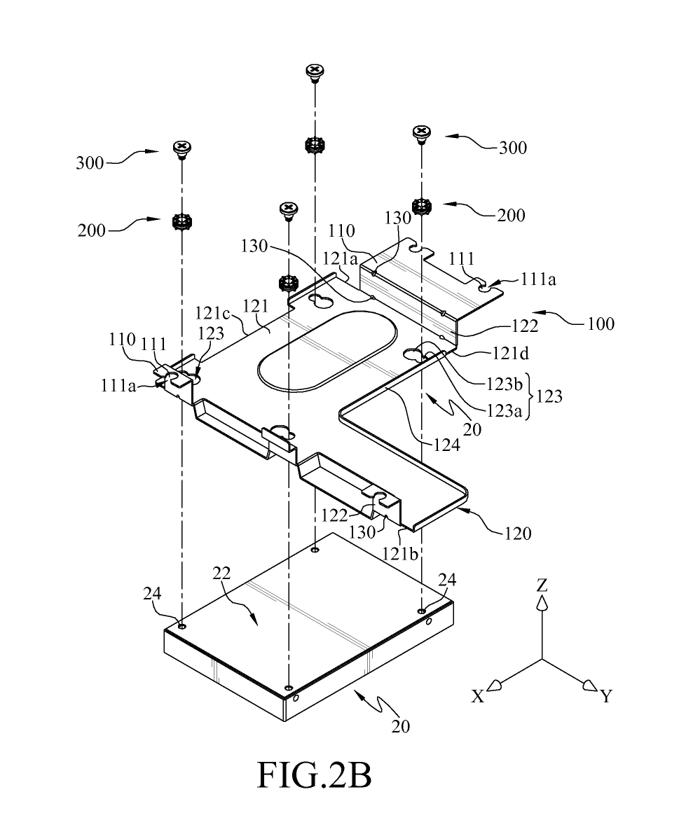

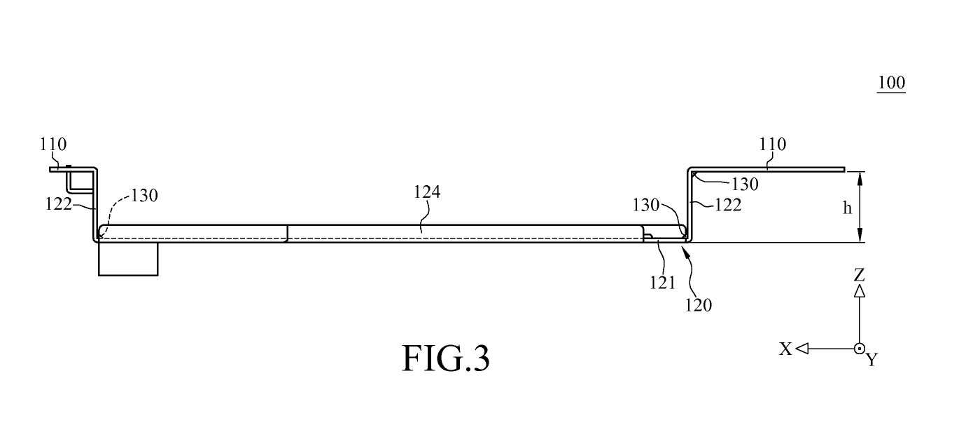

FIG. 1A is a perspective view of a shock absorber, a case and a load according to a first embodiment. FIG. 1B is a top view of FIG. 1A. FIG. 2A is an exploded view of an assembling element and the case in FIG. 1A. FIG. 2B is an exploded view of the assembling element and the load in FIG. 2A. FIG. 3 is a cross-sectional view of the assembling element in FIG. 1A.

In this embodiment, a shock absorber 10 is configured to install a load 20 on a case 30 of electronic device. The shock absorber 10 is configured to dissipate the vibration on the load 20 and this method of dissipating the vibration will be described at a later stage. The load 20, for example, is a disk or a CD-ROM which prone to vibration. The case 30 is a case of an electronic device such as a case of a personal computer and a case of an industry computer.

The shock absorber 10 comprises an assembling element 100, a plurality of first absorbing elements 200, a plurality of first locking elements 300, a plurality of second absorbing elements 400 and a plurality of second locking elements 500.

The assembling element 100 comprises two assembling plates 110 and a buffer plate 120 which is curved. The two assembling plates 110 are connected respectively to opposite two sides of the buffer plate 120. The buffer plate 120 has a bottom plate 121 and two side plates 122. A plurality of first assembling holes 123 is located at the bottom plate 121 respectively. The bottom plate 121 has a first side 121a and a second side 121b opposite to each other, and a third side 121c and a forth side 121d opposite to each other. One side of each of the two side plates 122 is connected to the first side 121a and the second side 121b. Another side of each of the two side plates 122 is connected to each of the two assembling plates 110 so that the buffer plate 120 is U-shaped (as shown in FIG. 3). In each of the two side plates 122, a height h of the side plate 122 is 12.5˜14.1 millimeters. In this embodiment, the bottom plate 121 and the two assembling plates 110 are not coplanar, and the height difference h between the bottom plate 121 and the two assembling plates 110 is 12.5˜14.1 millimeters. Therefore, the buffer plate 120 provides elastic deformation to dissipate the vibration transmitting along x-axis (as shown in FIG. 2A). The assembling element 100, for example, is produced by machining a single metal plate or assembling multiple metal plates.

The buffer plate 120 has a plurality of first assembling holes 123. Each first assembling hole 123 has a release part 123b and a fastening part 123a. The diameter of the release part 123b is greater than the diameter of the fastening part 123a so that a hardy hole is formed to increase the assembling efficiency of the first absorbing element 200.

The two assembling plates 110 each have a plurality of second assembling holes 111. In each of the second assembling holes 111, the second assembling hole 111 has a notch 111a to make the second absorbing element 400 be assembled more conveniently. Shape of the second assembling hole 111 may be the same as the first assembling hole 123.

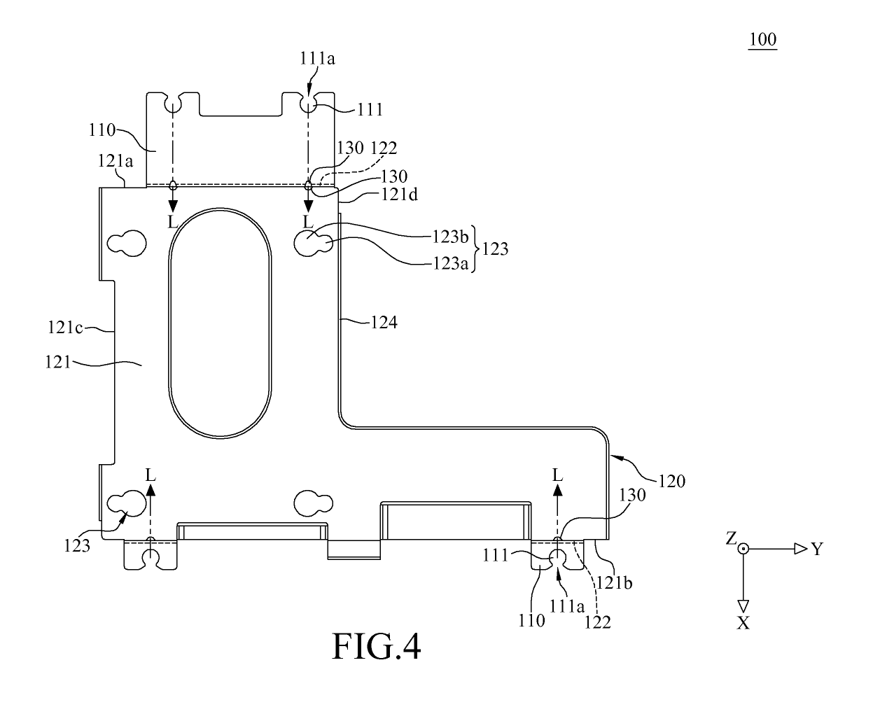

FIG. 4 is a top view of the assembling element in FIG. 2B. As seen in FIG. 2A and FIG. 4, the assembling element 100 further comprises a plurality of strengthening elements 130. Each of the strengthening elements 130 is located on the extended line L in the direction from the center of the second assembling hole 111 to the side plate 122. The strengthening elements 130 are located at the bending position between the two side plates 122 and the two assembling plates 110 respectively. The strengthening elements 130 are located at the bending position between the two side plates 122 and the bottom plate 121 respectively. The strengthening elements 130 are configured to strengthen the assembling element 100 and dissipate vibration of the assembling element 100 transmitting along x-axis. In this embodiment, the extended lines are perpendicular to the two side plates 122 (as shown in FIG. 2A, the extended lines are parallel to x-axis). The strengthening elements 130, for example, are convex hulls formed by stamping the bending position of the assembling element 100 from outer side.

Furthermore, the buffer plate 120 further includes two strengthening plates 124. The two strengthening plates 124 are connected to the third side 121c and the forth side 121d respectively. Consequently, the two strengthening plates 124 dissipate the vibration of the assembling element 100 transmitting along y-axis. In this embodiment, vibration transmitting along different axes is able to be dissipated by self-strengthening and U-shaped frame.

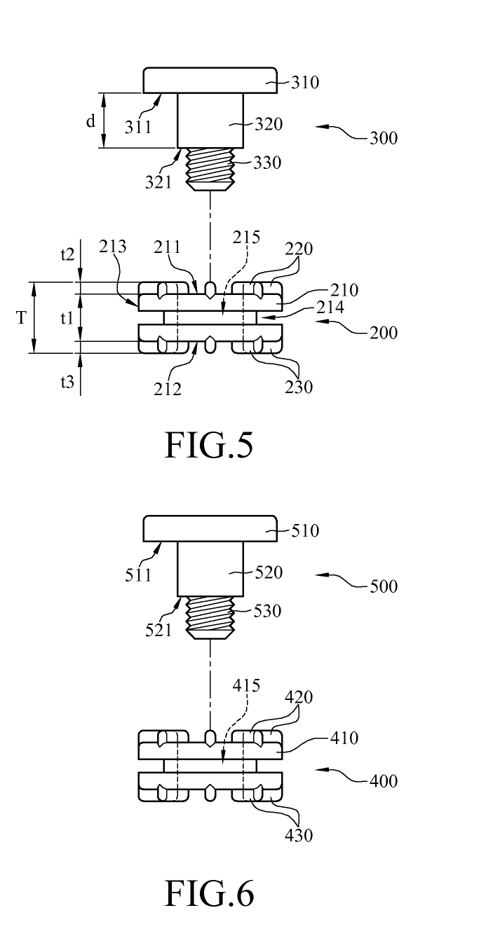

FIG. 5 is an exploded view of a first absorbing element and a first locking element in FIG. 2B. Referring to FIG. 5, the first absorbing elements, for example, are plastic washers. Each of the first absorbing elements has a first absorbing body 210, a plurality of first convex parts 220 and a plurality of second convex parts 230. Each of the first absorbing bodies 210 has a top section 211, a bottom section 212 and a side section 213. The corresponding two sides of the side section 213 are connected to the top section 211 and the bottom section 212 respectively. Each of the first absorbing bodies 210 further comprises a concave 214 and a first opening hole 215. The concave 214 is located at the side section 213, and the first absorbing body 210 is detachably installed on the fastening part 123a of the first assembling hole 123 to make the plates surrounding the fastening part 123a be embedded in the concave 214. The first opening hole 215 passes through the top section 211 and the bottom section 212. The first convex parts 220 and the second convex parts 230 are located at the top section 211 and the bottom section 212 respectively. In this embodiment, the first convex parts 220 and the second convex parts 230 are strip-shaped and are respectively arranged from the center of the first opening hole 215 in radial. Furthermore, the position of orthographic projection of the first convex parts 220 on the bottom plate 212 overlaps the position of the second convex parts 230.

In each of the first convex parts 220 and the second convex parts 230, the shape and methods of arranging and positioning are not limited thereto. In other embodiments, a plurality of first convex parts 220 and a plurality of second convex parts 230 are round-shaped. The first convex parts 220 and the second convex parts 230 are arranged in parallel. The first convex parts 220 and the second convex parts 230 may also be arranged in a staggered manner.

The first locking element 300, being screws for example, passes through the first opening hole 215 and are fixed to the load 20 to fix the load 20 on the assembling element 100. The load 20 is a hard disk, for example. The first locking element 300 includes a head part 310, a protruding part 320 and a threaded part 330 which are connected together and have different outside diameters. In this embodiment, the outside diameter of the head part 310 is greater than the outside diameter of the protruding part 320, and the outside diameter of the protruding part 320 is greater than the outside diameter of the threaded part 330. The head part 310 has a first limit surface 311. The top section 211 faces the first limit surface 311. The protruding part 320 protrudes from the first limit surface 311 and has a second limit surface 321. The threaded part 330 protrudes from the second limit surface 321. The vertical distance d between the first limit surface 311 and the second limit surface 321 is less than the thickness T of the first absorbing element 200. The first limit surface 311 is abutted on the first convex parts 220. The threaded part 330 is able to be wholly plunged into a locking hole 24 to ensure that the second limit surface 321 is abutted on a load surface 22. Therefore, the first absorbing element 200 is elastically clamped between the first limit surface 311 and the load surface 22.

Now the advantages of the first convex parts 220 and the second convex parts 230 will be illustrated. When a force is applied on two elastic bodies, the one with narrower width has larger elastic deformation. Therefore, the reason why the first convex parts 220 and the second convex parts 230, which are far less than the first absorbing bodies, are disposed on the first absorbing bodies 210 is that the elastic deformation of the first absorbing element 200 is more easily tuned to intended deformation. The elastic deformation cuts off the vibration wave and decreases vibration intensity to improve the capability of the shock absorber 10.

Nevertheless, better scale relation of the vertical distance d (the distance between the first limit surface 311 and the second limit surface 321) and the thickness T (thickness of the first absorbing element 200) is that the vertical distance d is not only less than the thickness T (a thickness of the first absorbing bodies 210 (t1) plus a thickness of the first convex parts 220 (t2) plus a thickness of the second convex parts 230 (t3)) but also greater than the thickness of the first absorbing bodies 210 (t1), which makes the deformation position of the first absorbing element 200 concentrates in the first convex parts 220 and the second convex parts 230. In this embodiment, the thickness of the first absorbing element 200 is 4 millimeters. Both the thicknesses of the first convex part 220 and the second convex part 230 are 0.6 millimeter. The vertical distance between the first limit surface 311 and second limit surface 321 is 3.3 millimeters (less than 4 millimeters but greater than 2.8 millimeters).

FIG. 6 is an exploded view of a second absorbing element and a second locking element in FIG. 2A. As seen in FIG. 6, the specification of the second absorbing elements 400 is the same as the specification of the first absorbing elements 200. The second absorbing element 400 includes a second absorbing body 410, a plurality of third convex parts 420 and a plurality of forth convex parts 430. The second absorbing body 410 further has a second opening hole 415. The second absorbing body 410 is detachably installed on the second assembling hole 111. The third convex parts 420 and the forth convex parts 430 are located at opposite two sides of the second absorbing body 410. The structures and the connected relations of the second absorbing bodies 410, the third convex parts 420 and the forth convex parts 430 are similar to the first absorbing bodies 210, the first convex parts 220 and each of the second convex parts 230 respectively so that detail description is not described again.

The second locking element 500, for example, is screw and the specification is the same as the specification of the first locking element 300. The second locking element 500 passes through the second opening hole 415 and are fixed to the case 30, which makes the assembling element 100 be fixed on the case 30. The second locking element 500 includes a head part 510, a protruding part 520, and a threaded part 530 which are connected together. The head part 510 has a first limit surface 511. The protruding part 520 protrudes from the first limit surface 511 and has a second limit surface 521. The threaded part 530 protrudes from the second limit surface 521. The first limit surface 511 is abutted on the third convex parts 420. The threaded parts 530 are fixed to the case 30. The second limit surface 521 is abutted on the case 30 so that the second absorbing element 400 is elastically clamped between the second absorbing element 400 and the case 30.

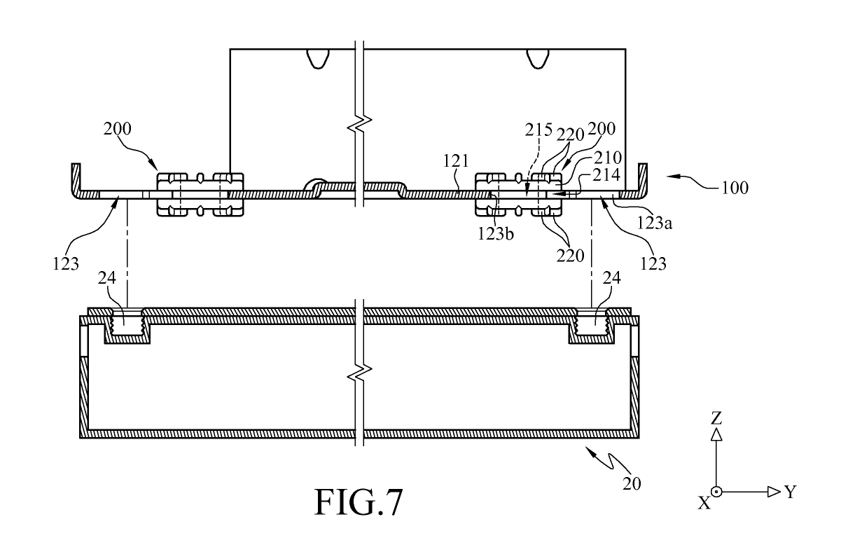

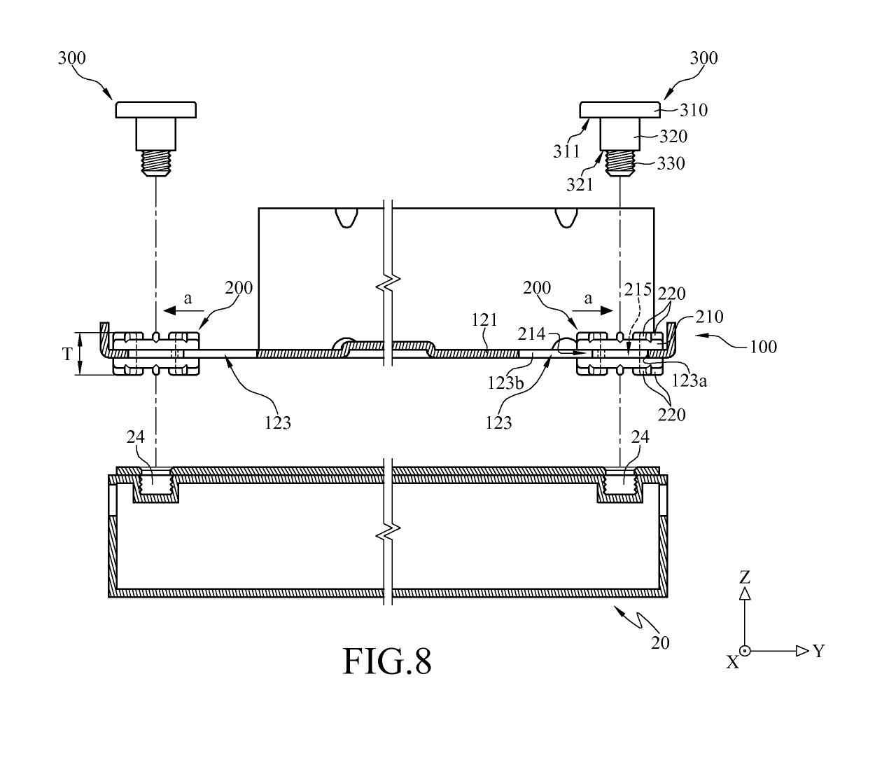

FIG. 7 to FIG. 11 are assembling drawings of the shock absorber, the case and the load in FIG. 1. As shown in FIG. 7 and FIG. 8, the first absorbing element 200 is disposed in the release part 123b of the first assembling hole 123. Next the first absorbing element 200 is slid to the fastening part 123a from the release part 123b (along the direction indicated by an arrow a), which makes the first absorbing element 200 be embedded in the bottom plate 121. Meanwhile, the first absorbing element 200 is not compressed so that the thickness T (sum of the thicknesses of the first absorbing body 210, the first convex part 220 and the second convex part 230) is greater than the vertical distance d (the distance between the first limit surface 311 and the second limit surface 321).

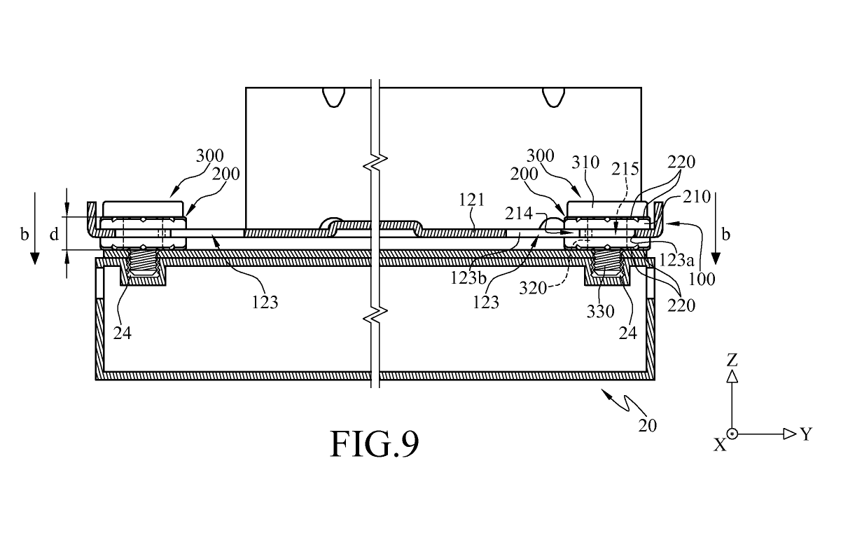

As shown in FIG. 9, the first locking element 300 passes through the first opening hole 215 along the direction indicated by an arrow b and is fixed to the locking hole 24 of the load 20. At the same time, the first absorbing element 200 is compressed by the first limit surface 311 and the load surface 22 so that the thickness T is the same as the vertical distance d, which makes the first absorbing element 200 provide elasticity to reduce the vibration intensity delivered from the assembling element 100 to the load 20.

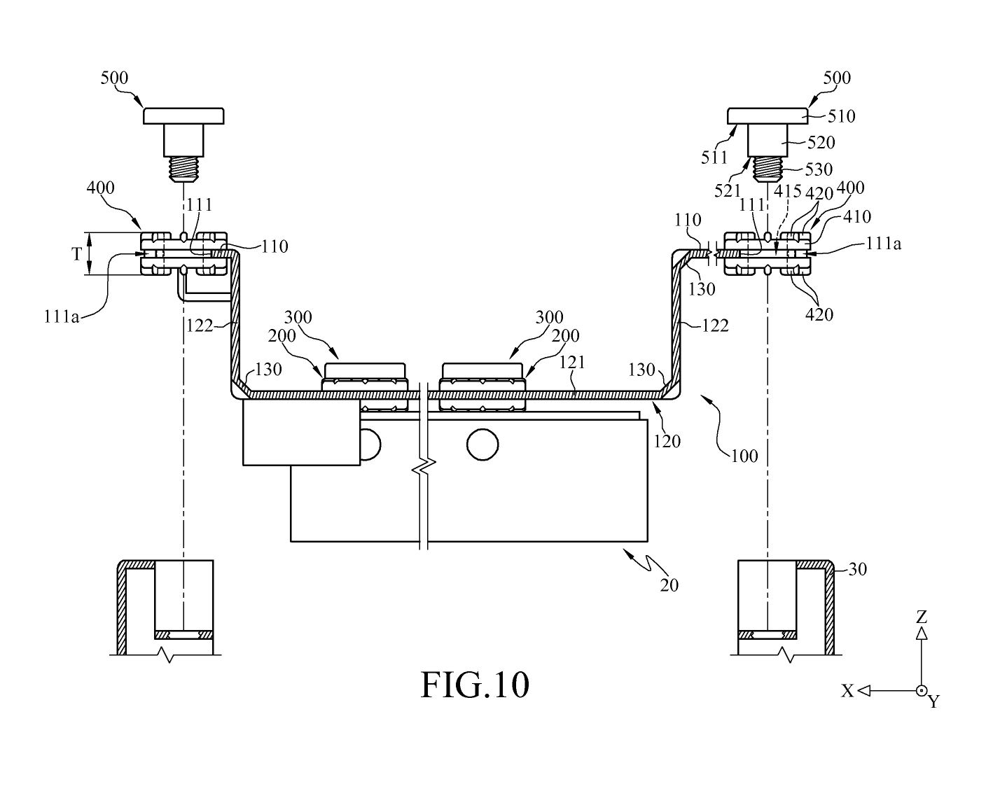

As shown in FIG. 10, the second absorbing element 400 is assembled in the second assembling hole 111. Meanwhile, the first absorbing element 200 is not compressed so that the thickness T (sum of the thicknesses of the second absorbing body 410, the third convex part 420 and the forth convex part 430) is greater than the vertical distance d (the distance between the first limit surface 511 and the second limit surface 521).

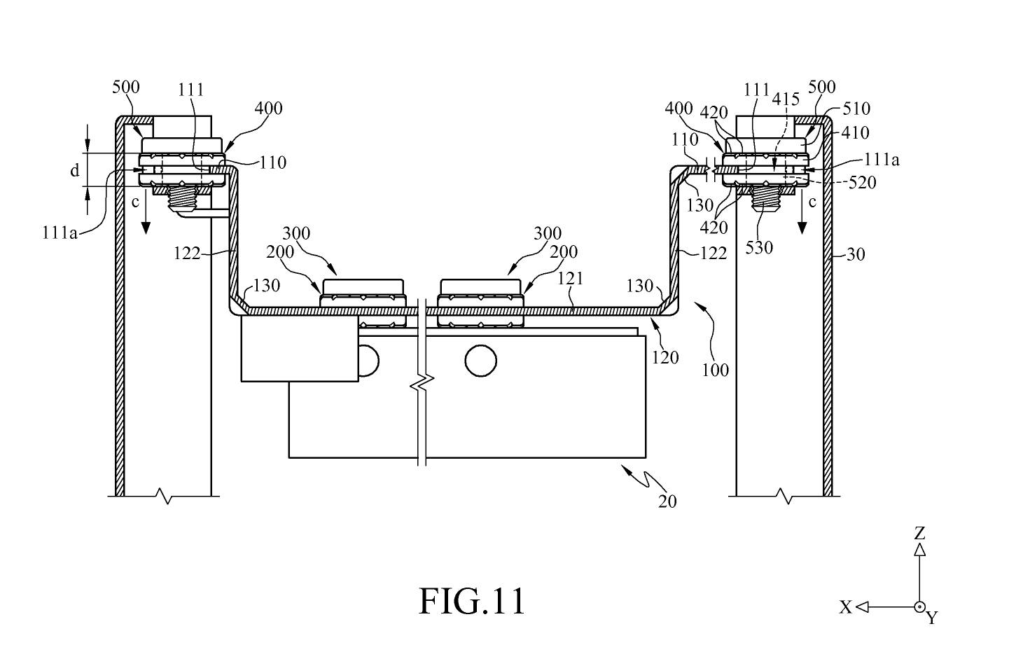

As shown in FIG. 11, the second locking element 500 passes through the second opening hole 415 along the direction indicated by an arrow c and is fixed to the case 30. At the same time, the second absorbing element 400 is compressed by the first limit surface 511 and the case 30 so that the thickness T is the same as the vertical distance d, which makes the second absorbing element 400 provide elasticity to decrease the vibration intensity delivered from the assembling element 100 to the case 30. Dual shock absorbing effect is provided.

After practical tests, the maxima shock resistance of the electronic device using shock absorber 10 is improved to 1.0 Grms, from 0.5 Grms. Therefore, the electronic device using shock absorber 10 is able to satisfy most of the industry computer vibration tests.

According to the shock absorber in this embodiment, the buffer plate and the absorbing elements disposed between the load and the assembling frames are able to let the industry computer pass more stringent industry computer vibration tests.

Furthermore, the convex parts with narrower widths are disposed on the absorbing bodies so that the first absorbing element is more easily tuned to intended deformation. The elastic deformation cuts off the vibration wave and decreases vibration intensity to improve the effects of shock absorption.

The absorbing elements are not only disposed between the case and the assembling element but also disposed between the load and the assembling element to double the improvement of the effects of shock absorption. Moreover, both the third side and the forth side of the bottom plate have strengthening plates which are able to dissipate the vibration on y-axis.

What is claimed is:

1. A shock absorber, comprising:
an assembling element including two assembling plates and a buffer plate which is curved, wherein the two assembling plates are respectively connected to opposite two sides of the buffer plate, and the buffer plate has a plurality of first assembling holes;
a plurality of first absorbing elements having a first absorbing body and a plurality of first convex parts respectively, wherein the first absorbing body has a first opening hole, each of the first absorbing bodies is detachably installed on the first assembling hole, and the first convex parts are located on one side of the first absorbing body; and
a plurality of first locking elements having a head part, a protruding part and a threaded part respectively, wherein the head part has a first limit surface, the protruding part protrudes from the head part and has a second limit surface, the threaded part protrudes from the second limit surface, vertical distance between the first limit surface and the second limit surface is shorter than thickness of the first absorbing element, the first locking elements pass through the first opening holes respectively, the first limit surfaces of the first locking elements is abutted on the first convex parts of the first absorbing bodies respectively, and the threaded parts of the first locking elements are configured to fix a load to make the second limit surface being abutted on the load surface, which makes the first absorbing elements being elastically clamped between the first limit surface and the load surface.

2. The shock absorber according to claim 1, wherein each of the first absorbing bodies has a top section, a bottom section and a side section, opposite two sides of the side section are connected to the top section and the bottom section, the top section faces the head parts of the first absorbing elements, and the first convex parts are located at the top section.

3. The shock absorber according to claim 2, wherein each of the first absorbing elements further comprises a plurality of second convex parts, and the second convex parts are located at the bottom section.

4. The shock absorber according to claim 3, wherein the first convex parts and the second convex parts are strip-shaped and are arranged in radial.

5. The shock absorber according to claim 3, wherein the position of orthographic projection of the first convex parts on the bottom plate overlaps the position of the second convex parts.

6. The shock absorber according to claim 3, wherein the vertical distance between the first limit surface and the second limit surface is not only shorter than sum of thicknesses of the first absorbing body, the first convex part and the second convex part but also greater than the thickness of the first absorbing body.

7. The shock absorber according to claim 6, wherein the vertical distance between the first limit surface and the second limit surface is 3.3 millimeters, the thickness of the first absorbing element is 4 millimeters, and the thickness of the first convex part and the thickness of the second convex part are 0.6 millimeters respectively.

8. The shock absorber according to claim 2, wherein the first absorbing body has a concave, the concave is located at the side section, and part of the buffer plate is embedded in the concave.

9. The shock absorber according to claim 1, wherein the buffer plate has a bottom plate and two side plates, the first assembling holes are located at the bottom plate respectively, one side of each of the two side plates is connected to the bottom plate, and two sides of the bottom plate connected to the side plates are opposite to each other, another side of each of the two side plates is connected to the two assembling plates, and the height of each of the two side plates is 12.5˜14.1 millimeters.

10. The shock absorber according to claim 1, further comprising a plurality of second absorbing elements and a plurality of second locking elements, wherein the two assembling plates have a plurality of second assembling holes respectively, the second absorbing elements have a second absorbing body and a plurality of third convex parts respectively, each of the second absorbing bodies has a second opening hole, the second locking elements are detachably installed on the second assembling holes, the third convex parts are located at one side of the second absorbing body, and the second locking elements pass through the second opening holes respectively to be fixed to a case.

11. The shock absorber according to claim 10, wherein the second absorbing element further comprises a plurality of fourth convex parts, the third convex parts and the fourth convex parts are located at the second absorbing bodies respectively, and the third convex parts and the fourth convex parts are located on opposite two sides of the second absorbing body respectively

12. The shock absorber according to claim 1, wherein the assembling element further comprises a plurality of strengthening elements, the strengthening elements are located on the extended line respectively in the direction from the second assembling holes to the side plate, and the extended line is perpendicular to the side plate.

13. The shock absorber according to claim 12, wherein the assembling elements are located at the bending position between the two side plates and the two assembling plates and the bending position between the two side plates and the bottom plate respectively.

14. The shock absorber according to claim 1, wherein each of the first assembling holes has a release part and a fastening part, and the diameter of the release part is greater than the diameter of the fastening part.
